(19) United States
(12) Patent Application Publication
(10) Pub. No.: US 2020/0265230 A1
(43) Pub. Date: Aug. 20, 2020

(54) COMPUTER READABLE STORAGE MEDIUM, INFORMATION SUPPLYING METHOD AND INFORMATION SUPPLYING SYSTEM

(71) Applicant: TANAKA FOODS CO., LTD., Hiroshima City (JP)

(72) Inventor: Shigeki TANAKA, Hiroshima (JP)

(73) Assignee: TANAKA FOODS CO., LTD., Hiroshima City (JP)

(21) Appl. No.: 16/428,050

(22) Filed: May 31, 2019

(30) Foreign Application Priority Data
Feb. 15, 2019 (JP) 2019-025999

(51) Int. Cl. G06K 9/00; G06T 11/60; H04N 5/232; G06F 21/44; G06Q 30/02

(52) U.S. Cl. CPC G06K 9/00671; G06T 11/60; G06K 2209/25; G06F 21/44; G06Q 30/0268; H04N 5/232935

(57) ABSTRACT

An information supplying program includes: an authentication step of performing authentication for accessing an AR library causing a camera to operate as an AR camera; a photography step of photographing an item packaging design of merchandise by the camera; a selection step of selecting a photoframe image based on the item packaging design of merchandise that was photographed from among a plurality of sets of information related to the merchandise; and a display step of displaying the selected photoframe image on a display unit.

This application is based on and claims the benefit of priority from Japanese Patent Application No. 2019-025999, filed on 15 Feb. 2019, the content of which is incorporated herein by reference.

### BACKGROUND OF THE INVENTION

### Field of the Invention

The present invention relates to a computer readable storage medium, information supplying method and information supplying system.

### Related Art

For example, technology has been known of augmented reality (AR: Augmented Reality) which superimposes, on a live-view image captured by a digital camera, data such as of text and audio related to a store, merchandise, etc. captured in this image, for example. Then, accompanying the spread of mobile communication terminals such as smart phones and tablet-type terminals having a camera function, various services using AR technology are being proposed (refer to Patent Document 1, for example).

Patent Document 1: Japanese Unexamined Patent Application, Publication No. 2016-012349

### SUMMARY OF THE INVENTION

However, the technology of Patent Document 1 simply provides assembly installation information, handling instruction information, etc. of the merchandise to a customer having purchased the merchandise, and it may be difficult to actively motivate purchase of the merchandise to a user.

The present invention has an object of providing a service motivating the purchase of merchandise to a user.

A non-transitory computer readable storage medium encoded with an information supplying program according to a first aspect of the present invention is executed by a computer (for example, the terminal device 1 described later) having a display unit (for example, the display unit 12 described later), the program including: an authentication step of performing authentication for accessing an AR library which causes an imaging device (for example, the camera 14 described later) to operate as an AR camera; a photography step of photographing an item packaging design (the individual packaging 300 described later) of merchandise by the imaging device; a selection step of selecting a set of information (for example, the photoframe image 410 described later) based on the item packaging design of merchandise that was photographed, from among a plurality of sets of information related to the merchandise; and a display step of displaying the set of information selected on the display unit.

According to a second aspect of the present invention, the selection step may select the information as one photoframe image randomly from among a plurality of photoframe images stored to correspond to the item packaging design photographed, the display step may superimpose the photoframe image which was selected on a live-view image of the imaging device and displays on the display unit, in which the information supplying program may further include a storage step of storing a composite image (for example, the composite image 500 described later) made by compositing an image photographed by the imaging device and the photoframe image.

According to the third aspect of the present invention, the item packaging design may include at least one of a letter, a picture pattern and a graphic.

An information supplying method according to a fourth aspect of the present invention includes: a step of performing authentication for accessing an AR library which causes an imaging device (for example, the camera 14 described later) to operate as an AR camera; a step of photographing an item packaging design (for example, the individual packaging 300 described later) of merchandise by the imaging device; a step of selecting, from among a plurality of sets of information related to the merchandise, a set of information (for example, the photoframe image 419 described later) based on the item packaging design of the merchandise; and a step of displaying the set of information which was selected.

The information supplying system according to a fifth aspect of the present invention accepts images of merchandise from a user and provides information related to the merchandise to the user, the system including: an imaging device (for example, the camera 14 described later) which photographs an item packaging design of the merchandise; an authentication unit (for example, the authentication unit 31 described later) which performs authentication for accessing an AR library which causes the imaging device to operate as an AR camera; a selection unit (for example, the selection unit 32 described later) which selects, from among a plurality of sets of information related to the merchandise, a set of information (for example, the photoframe image 410 described later) based on the item packaging design (for example, the individual packaging 300 described later) of the merchandise which was photographed by the imaging device; and a display unit (for example, the display unit 12 described later) which displays the set of information which was selected.

According to the present invention, it is possible to provide a service motivating the purchase of merchandise to a user.

### BRIEF DESCRIPTION OF THE DRAWINGS

FIG. 1 is a view showing a configuration example of an information supplying system according to an embodiment;

FIG. 2A is a view for explaining a service serving as an application target of the information supplying system in FIG. 1;

FIG. 2B is a view for explaining a service serving as the application target of the information supplying system in FIG. 1;

FIG. 3 is a functional block diagram showing a functional configuration example of a terminal device in FIG. 1;

FIG. 4 is a functional block diagram showing a functional configuration example of the information supplying service in FIG. 1;

FIG. 5 is a view showing an example of a user interface during execution start of an application displayed on a display unit in FIG. 3;

FIG. 6 is a view showing an example of a user interface when the camera in FIG. 3 operates as an AR camera;

FIG. 7 is a view showing an example of capturing a merchandise image based on the user interface in FIG. 6;

FIG. 8 is a view showing an example of a user interface displayed on a display unit in FIG. 3;

FIG. 9 is a view showing an example of a captured image;

FIG. 10 is a view showing an example of a photoframe image differing from the photoframe image in FIG. 8;

FIG. 11 is a flowchart for explaining information supplying processing of the information supplying system in FIG. 11; and

FIG. 12 is a flowchart for explaining information supplying processing of the information supplying system in FIG. 1.

### DETAILED DESCRIPTION OF THE INVENTION

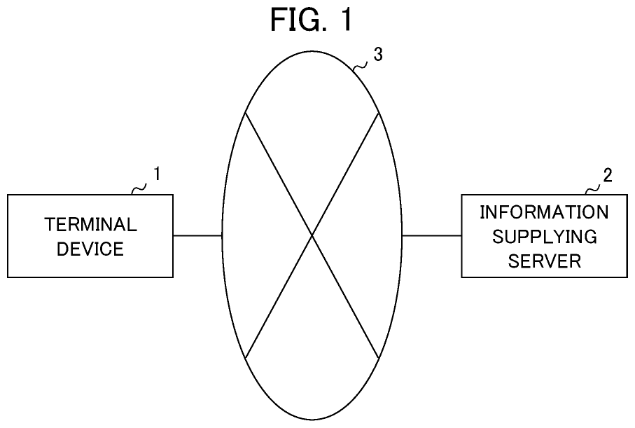

Hereinafter, an embodiment will be explained using the drawings. FIG. 1 is a view showing a configuration example of an information supplying system according to the embodiment. As shown in FIG. 1, the information supplying system is configured so as to include a terminal device 1 and an information supplying server 2. The terminal device 1 and information supplying server 2 are connected to each other via a predetermined network 3 such as the Internet.

The terminal device 1 is a portable communication terminal such as a smart phone or tablet-type terminal, and connects with a network 3 via a base station (not shown) of a telecommunication carrier contracted by the user handling the communication protocol (for example, 4G, 5G, etc.), so as to communicate with the information supplying server 2. Alternatively, the terminal device 1 may connect with the network 3 by wirelessly connecting with an access point (not shown) of wireless LAN (for example, WiFi (registered trademark)), so as to communicate with the information supplying server 2. It should be noted that, although one terminal device 1 connects to the network 3 in FIG. 1, it is not to be limited thereto, and a plurality of two or more terminal devices 1 may connect to the network 3 and communicate with the information supplying server 2.

The information supplying server 2, for example, is a server such as a cloud server, and supplies information of merchandise, display of an image character of the merchandise, a scene showing a recommended use example of the merchandise, or information such as an image of this image character or game, as required from the terminal device 1.

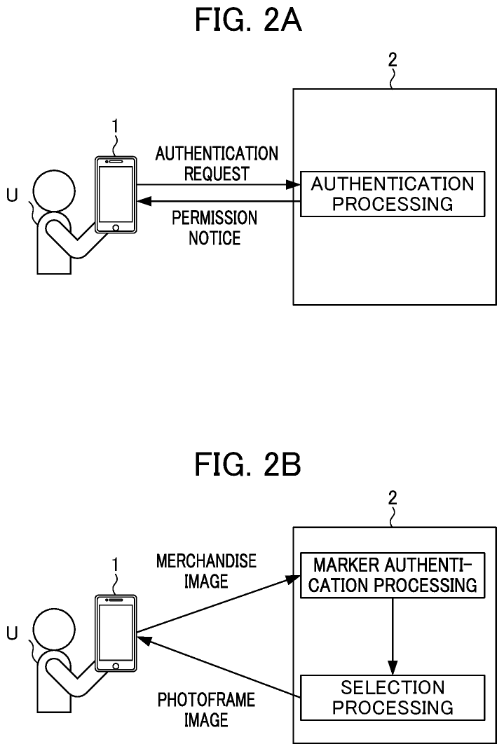

FIG. 2 is a view showing a service (hereinafter also referred as “present service”) serving as an application target of the information supplying system in FIG. 1. The terminal device 1 is managed by a user U. The information supplying server 2 is managed by the provider of the present service, for example.

It should be noted that the terminal device 1 downloads in advance an application program for receiving the present service from a link destination published on the item packaging, etc. of merchandise purchased by the user U, and then installs. Then, the terminal device 1, based on an input instruction by the user U, executes the installed application program, and registers in advance the information related to the user U (for example, ID, password, etc.) based on a known method, in the information supplying server 2. It should be noted that the full name, age, mailing address, etc. may be included in the information related to the user U. In addition, in the following explanation, “application program” is referred to as “application” in short. Then, unless otherwise stated, application is the “application program”.

More specifically, for example, as shown in FIG. 2A, with the present service, the terminal device 1 executes the application based on the input operation by the user U, and in order to cause a camera 14 (described later) of the terminal device 1 to act as the AR camera, sends an authentication request including authentication information of the user U (for example, ID, password, etc.) to the information supplying server 2.

The information supplying server 2 executes authentication processing which determines whether the authentication information of the user U included in the authentication request received from the terminal device 1 and the registered information of the user U which was registered in advance match. The information supplying server 2, in the case of the authentication information of the user U received from the terminal device 1 and the registered information of the user U matching, sends a permission notice permitting access to the information supplying server 2 to the terminal device 1. Then, the terminal device 1, by receiving the permission notice from the information supplying server 2, determines that a license authentication for accessing the AR library built into the application program was received, and causes the camera 14 to act as the AR camera.

Next, as shown in FIG. 2B, with the present service, the terminal device 1 captures an item packaging design (main body) of purchased merchandise by the camera 14 of the terminal device 1 as an AR marker, based on a photographing operation by the user U. Then, the terminal device 1 sends a merchandise image of the photographed merchandise to the information supplying server 2. The information supplying server 2 executes marker authentication processing based on the merchandise (AR marker) in the received merchandise image, and marker design which is registered in advance in a storage unit 22 (described later) such as an HDD (Hard Disk Drive) included in the information supplying server 2. Then, the information supplying server 2 randomly selects, from among a plurality of sets of information related to merchandise specified by the marker authentication relative to the merchandise information, for example, one photoframe image in which a picture is captured together with an image character of this merchandise by way of an AR function, and sends the selected photoframe image to the terminal device 1. The terminal device 1 stores a composite image in which the image captured by the camera 14 of the terminal device 1 and the received photoframe image are superimposed based on the photographing operation by the user U, in the storage unit 13 (described later) such as EEPROM (Electrically Erasable Programmable Read-Only Memory) included in the terminal device 1.

In this way, with the present service, the user U can receive information only obtained by purchasing the merchandise (for example, photoframe image). The present service can thereby motivate to the user U the purchase of this merchandise also the next time in order to obtain this information. In addition, with the present service, the information supplying server 2, for example, has a plurality of types of photoframe images, selects one photoframe randomly for every marker authentication, and sends to the terminal device 1. The present service can thereby motivate to the user U to purchase this merchandise also the next time in order to obtain all photoframe images.

### <Configuration of Terminal Device 1>

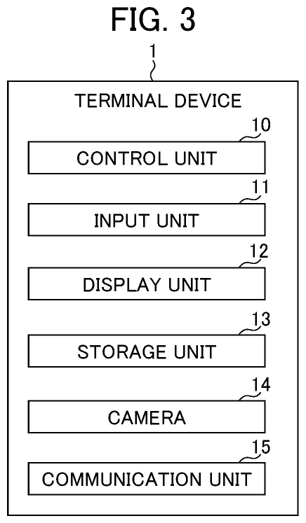

FIG. 3 is a functional block diagram showing a functional configuration example of the terminal device 1 in the information supplying system in FIG. 1. As shown in FIG. 3, the terminal device 1 is a portable communication terminal such as a smart phone, and is configured to include a control unit 10, an input unit 11, a display unit 12, a storage unit 13, a camera 14 and a communication unit 15.

The control unit 10 is a portion which controls the entirety of the terminal device 1, and realizes various functions of the present embodiment by appropriately reading out and executing various programs stored in the storage unit 13. The control unit 10 may be a CPU (Central Processing Unit).

The input unit 11 is realized by a touch panel or the like, and accepts various manipulations from the user U.

The display unit 12 is realized by a liquid crystal display or the like, and displays various information, for example. The storage unit 13 is configured by ROM (Read Only Memory), RAM (Random Access Memory), EEPROM or the like, and stores various data such as installed applications.

The camera 14 is a digital camera having an imaging optical system such as lenses and image sensor elements such as CMOS (Complementary Metal-Oxide-semiconductor), and photographs in response to an photographing operation by the user U. The communication unit 15 connects with the network 3 via a base station of the telecommunication carrier contracted by the user U handling the communication protocol (for example, 4G, 5G, etc.), and controls communication performed with the information supplying server 2. Alternatively, the communication unit 15 may connect with the network 3 by wirelessly connected with an access point of wireless LAN (for example, WiFi), and control communication performed with the information supplying server 2.

### <Configuration of Information Supplying Server 2>

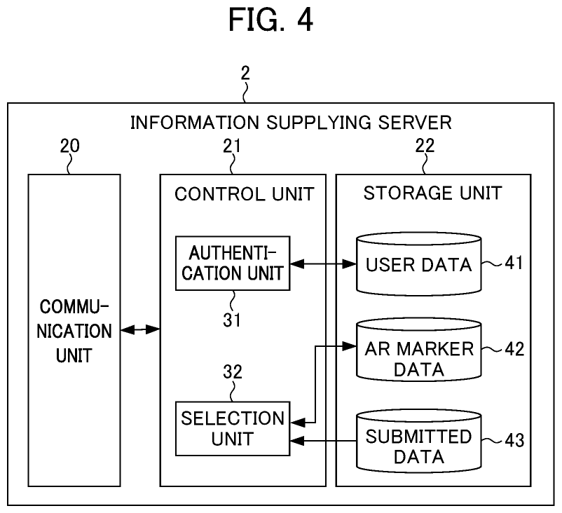

FIG. 4 is a functional block diagram showing a functional configuration example of the information supplying server 2 in the information supplying system in FIG. 1. The information supplying server 2 is a server such as a cloud server, and is configured to include a communication unit 20, control unit 21 and storage unit 22, as shown in FIG. 4.

The communication unit 20 connects with the network 3 via wires or wirelessly, and controls communication performed with the terminal device 1. The control unit 21 is a portion which controls the entirety of the information supplying server 2, and realizes various functions of the present embodiment by appropriately reading out and executing various programs stored in the storage unit 22. For example, the control unit 21 has functions as an authentication unit 31 and selection unit 32. The control unit 21 may be a CPU.

The authentication unit 31 performs authentication for accessing an AR library which causes the camera 14 of the terminal device 1 to act as the AR camera. More specifically, the authentication unit 31 receives from the terminal device 1, via the communication unit 20, an authentication request including authentication information of the user U (for example, ID, password, etc.) in order to access the AR library causing the camera 14 to act as the AR camera. Then, the authentication unit 31 determines whether or not the authentication information of the user U included in the authentication request received from the terminal device 1 and the registered information of the user U registered in the user data 41 of the storage unit 22 described later match. The authentication unit 31, in the case of the authentication information of the user U received from the terminal device 1 and the registered information of the user U matching, sends a permission notice permitting access to the information supplying server 2 by the terminal device 1 to the terminal device 1 via the communication unit 20.

Then, by receiving the permission notice from the information supplying server 2 via the communication unit 15, the control unit 10 of the terminal device 1 determines that license authentication for accessing to the AR library included in the application program was received, and causes the camera 14 to act as the AR camera.

Thereafter, the authentication unit 31 receives the merchandise image photographed by the camera 14 of the terminal device 1 via the communication unit 20. The authentication unit 31 executes marker authentication processing based on the item packaging design (AR marker) of the merchandise in the received merchandise image, and the marker design which is registered in advance in the AR marker data 42 of the storage unit 22 described later. It should be noted that the marker authentication processing can use a well-known method, and thus explanation will be omitted.

The selection unit 32 selects information based on the item packaging design of merchandise in the merchandise image, among a plurality of sets of information provided for every merchandise stored in the submitted data 43 of the storage unit 22 described later. More specifically, the selection unit 32 randomly selects from the submitted data 43 from among a plurality of sets of information related to merchandise specified by the marker authentication by the authentication unit 31, one photoframe image in which a picture is taken together with the image character of this merchandise by way of the AR function, for example. The selection unit 32 sends the selected photoframe image to the terminal device 1 via the communication unit 20.

The storage unit 22 is configured by ROM, RAM, HDD or the like, and stores the user data 41, AR marker data 42 and submitted data 43. The user data 41 stores registration information (for example, ID, password, etc.) for every user U of the terminal device 1 which was registered in advance. The AR marker data 42 stores the marker design (AR marker) showing the item packaging design of merchandise for every merchandise. The submitted data 43 stores, for every merchandise, a plurality of sets of information provided to the user U, for example, information of merchandise, display of image character of merchandise, a scene showing recommended use example of merchandise, or photoframe image, video, etc. of this image character.

### <User Interface of Application>

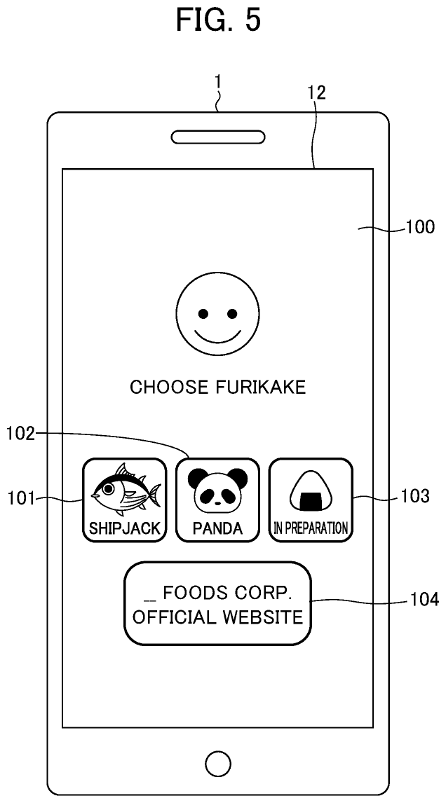

FIG. 5 is a view showing an example of a user interface during execution start of the application displayed on the display unit 12 in FIG. 3. It should be noted that, hereinafter, operation of the information supplying system in the case of “furikake” as the merchandise will be explained; however, it similarly applies to cases of merchandise other than “furikake”. In addition, until the user interface 100 in FIG. 5 is displayed on the display unit 12, with the terminal device 1, the authentication processing may be executed with the information supplying server 2, and may receive a permission notice from the information supplying server 2.

As shown in FIG. 5, the user interface 100 has buttons 101 to 103 of every merchandise of “furikake” which is being manufactured or marketed. In addition, the user interface 100 has a button 104 indicating connection to the official website of a manufacturer who is manufacturing or a vendor who is marketing the merchandise of this “furikake”.

The button 101 is a button selecting merchandise of “shipjack furikake”, and the button 102 is a button selecting merchandise of “panda furikake”, for example. The button 103 is a button indicating “in preparation”, and even if the button 103 is selected by a tap operation or the like on the input unit 11 by the user U, the terminal device 1 is set so as not to operate. It should be noted that, although the button 101 of “shipjack furikake” and button 102 of “panda furikake” are arranged on the user interface 100, it is not limited thereto, and three or more buttons may be arranged.

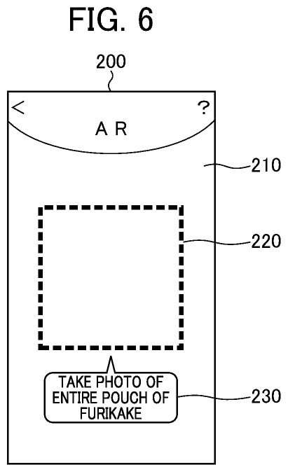

For example, in the case of the button 102 being selected by a tap operation or the like on the input unit 11 by the user U, the control unit 10 switches from the user interface 100, and displays the user interface 200 shown in FIG. 6 on the display unit 12. It should be noted that it operates similarly also in the case of the button 101 being selected. FIG. 6 is a view showing an example of the user interface 200 when the camera 14 in FIG. 3 is operating as the AR camera.

The camera 14 operates as the AR camera, and the user interface 200 displays in a region 210 an image of live view captured by the camera 14. Furthermore, the user interface 200 displays a rectangular region 220 indicated by dotted lines, and text 230 showing an instruction to the user U of “Take photo of entire pouch of furikake!”, by superimposing on the image of live view in the region 210.

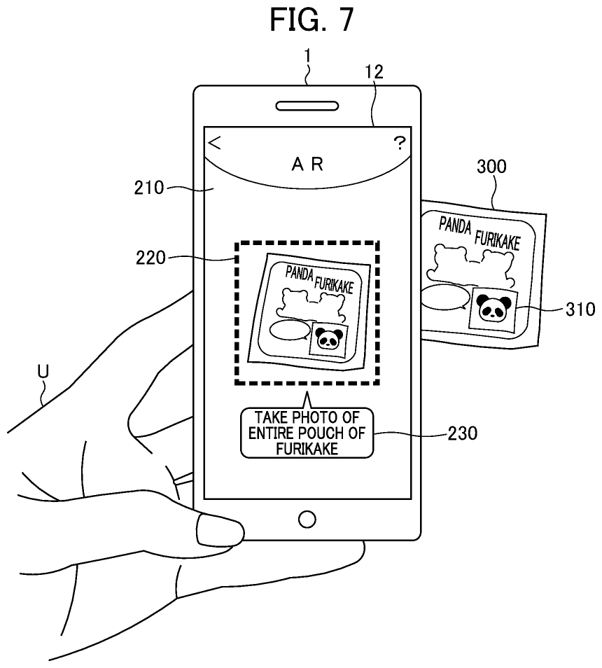

For example, the user U adjusts the posture of the camera 14 of the terminal device 1, so that the entirety of the individual packaging 300 of merchandise of “panda furikake” falls within the region 220, as shown in FIG. 7, in accordance with the instruction of the text 230 displayed on the user interface 200. Then, the control unit 10 causes the individual packaging 300 of the merchandise of “panda furikake” to be captured in the camera 14, in the case of the entirety of the individual packaging 300 falling into the region 220 in the image of live view of the camera 14, and being able to recognize the merchandise of “panda furikake” of the individual packaging 300. Then, the control unit 10 sends the merchandise image of the individual packaging 300 of “panda furikake” photographed to the information supplying server 2. FIG. 7 is a view showing an example of photographing a merchandise image based on the user interface 200 in FIG. 6.

It should be noted that the entirety of the individual packaging 300 falls into the region 220 based on the image of live view of the camera 14, and the processing of recognizing the merchandise of the individual packaging 300 can use image recognition processing using a known AR marker, and explanation thereof will be omitted.

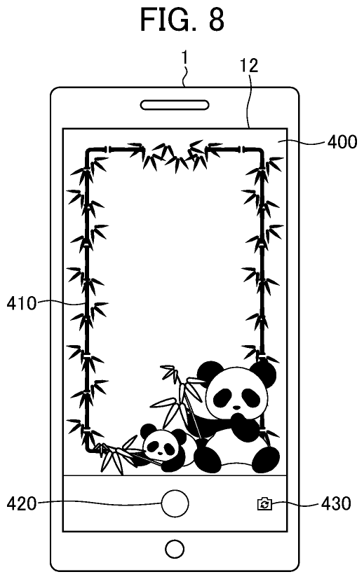

Then, the control unit 10 receives, from the information supplying server 2, a photoframe image relative to the merchandise image of “panda furikake” sent to the information supplying server 2 via the communication unit 15, and displays the user interface 400 shown in FIG. 8 on the display unit 12.

FIG. 8 is a view showing an example of the user interface 400 displayed on the display unit 12 in FIG. 3. The camera 14 operates as the AR camera, and the user interface 400 in FIG. 8 displays by superimposing the image of live view captured by the camera 14 and the photoframe image 410. In addition, the user interface 400 displays a photograph button 420 and a selfie switching button 430. The photograph button 420 is a button which accepts a photography instruction by being operated by way of a tap operation or the like on the input unit 11 by the user U, and causes the camera 14 to photograph. The selfie switching button 430 is a button which switches between the camera 14 and a camera (not shown) which faces the plane of the terminal device 1 on which the camera 14 is arranged, e.g. arranged on the plane on the side of the display unit 12, by being operated according to a tap operation or the like on the input unit 11 by the user U. By switching to the camera (not shown) arranged on this side of the display unit 12, the user U can take a selfie of the user U his/herself.

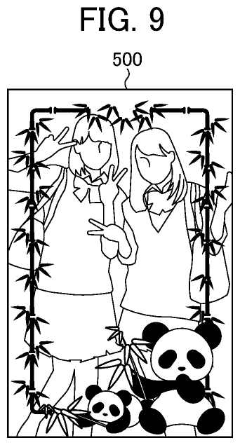

The control unit 10 causes the composite image 500 shown in FIG. 9 to be captured by the camera 14, according to the photography button 420 being operated by way of a tap operation or the like on the input unit 11 by the user U in the user interface 400. The control unit 10 stores the photographed composite image 500 in the storage unit 13. FIG. 9 is a view showing an example of the photographed composite image 500. In other words, the composite image 500 is a composite image made by compositing the image captured by the camera 14 and the photoframe image 410.

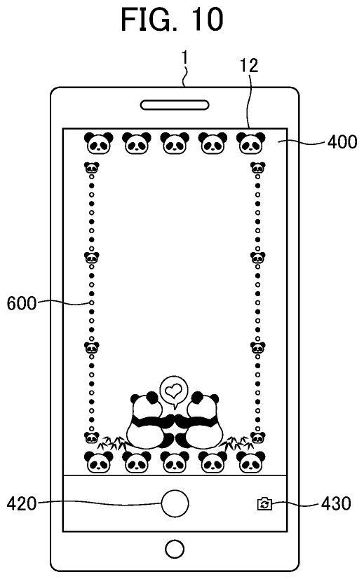

It should be noted that the photoframe image supplied by the information supplying server 2 is not limited to the photoframe image 410 in FIG. 8. For example, it may be the photoframe image 600 shown in FIG. 10.

FIG. 10 is a view showing an example of a photoframe image 600 which differs from the photoframe image 410 of FIG. 8. In other words, the information supplying server 2 may store a plurality of types of photoframe images in the submitted data 43 as in the photoframe image 410 and photoframe image 600, and every time receiving a merchandise image from the terminal device 1, may select one photoframe image randomly and send to the terminal device 1. The information supplying system can thereby motivate the user U to purchase the merchandise again next time in order to obtain all photoframe images, and can also give the user U an excited feeling of not knowing which photoframe image will be sent. In addition, by adding a new photoframe image in a timely manner, it is possible to continue motivation.

### <Information Supply Processing of Information Supplying System>

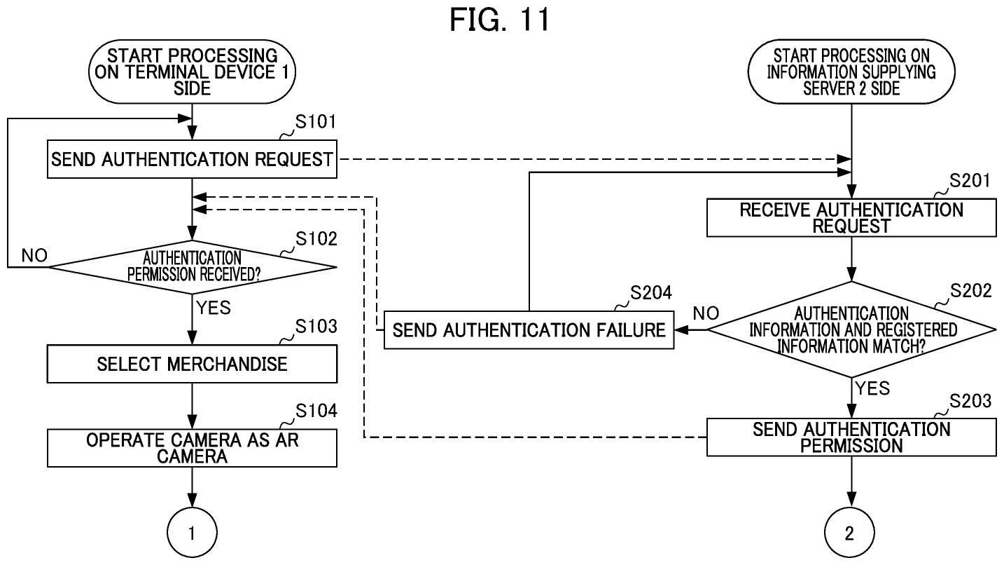

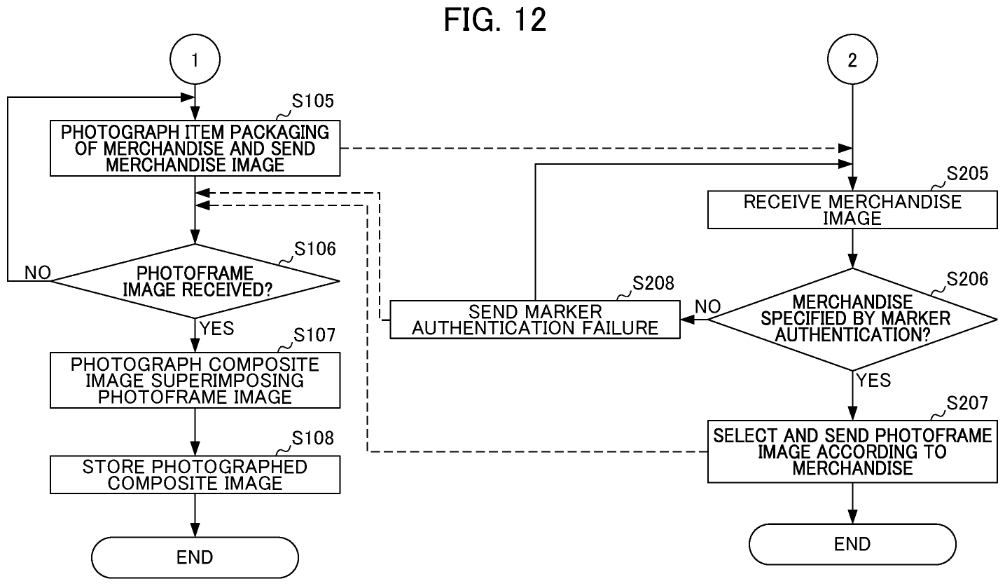

FIG. 11 and FIG. 12 are flowcharts for explaining the information supply processing of the information supplying system in FIG. 1. In Step S101, the control unit 10 of the terminal device 1 executes applications by the user U making a tap operation or the like on the icon of the application displayed on the display unit 12 via the input unit 11, and sends an authentication request including authentication information of the user U (for example, ID, password, etc.) to the information supplying server 2 via the communication unit 15. It should be noted that FIG. 11 and FIG. 12 shows the sending and receiving between the terminal device 1 and information supplying server 2 by dotted lines.

In Step S201, the authentication unit 31 of the control unit 21 of the information supplying server 2 receives authentication request of the user U sent by the terminal device 1 in Step S101 via the communication unit 20. In Step S202, the authentication unit 31 executes authentication processing to determine whether the authentication information of the user U included in the received authentication request and the registration information of the user U registered in the user data 41 match. In the case of the authentication information of the user U and the registration information of the user U matching (YES), the processing advances to Step S203, and in the case of the authentication information of the user U and the registration information of the user U not matching (NO), the processing advances to Step S204. In Step S203, the authentication unit 31 sends authentication permission to permit access to the information supplying server 2 to the terminal device 1 via the communication unit 20. In Step S204, the authentication unit 31 sends authentication failure not to permit access to the information supplying server 2 to the terminal device 1 via the communication unit 20. Subsequently, the processing returns to Step S201. In this case, the authentication unit 31 stands-by until receiving an authentication request of the user U from the terminal device 1.

In Step S102, the control unit 10 determines whether having received authentication permission from the information supplying server 2 via the communication unit 15. In the case of having received authentication permission (YES), the processing advances to Step S103, and in the case of not having received authentication permission (NO), i.e. case of receiving authentication failure, the processing returns to Step S101. In the case of the processing returning to Step S101, the control unit 10, for example, sends again the authentication request including the authentication information of the user U (for example, ID, password, etc.) to the information supplying server 2 via the communication unit 15. In Step S103, the control unit 10 displays the user interface 100 of FIG. 5 on the display unit 12, and accepts a selection of the merchandise furikake based on the tap operation or the like on the input unit 11 by the user U.

In Step S104, the control unit 10 conducts AR library access built-into the application, based on the authentication permission (license authentication) received in Step S102, causes the camera 14 to operate as the AR camera, and displays the user interface 200 of FIG. 6 on the display unit 12. In Step S105, the control unit 10 causes the individual packaging 300 of the merchandise of furikake selected in Step S103 to be photographed by the camera 14, and sends the photographed merchandise image to the information supplying server 2 via the communication unit 15.

In Step S205, the authentication unit 31 receives the merchandise image sent by the terminal device 1 in Step S105 via the communication unit 20. In Step S206, the authentication unit 31 executes marker authentication processing based on the item packaging design (AR marker) of the merchandise in the received merchandise image, and the marker design registered in the AR marker data 42, and determines whether it was possible to specify the merchandise of the merchandise image. In the case of being able to specify the merchandise (YES), the processing advances to Step S207, and in the case of not being able to specify the merchandise (NO), the processing advances to Step S208.

In Step S207, the selection unit 32 randomly selects one photoframe image from among a plurality of photoframe images related to the specified merchandise of furikake, and sends the selected photoframe image to the terminal device 1 via the communication unit 20. In Step S208, the authentication unit 31 sends a marker authentication failure to the terminal device 1 via the communication unit 20. Subsequently, the processing returns to Step S205. In this case, the authentication unit 31 stands-by until receiving a merchandise image from the terminal device 1, for example.

In Step S106, the control unit 10 determines whether or not a photoframe image was received from the information supplying server 2 via the communication unit 15. In the case of having received a photoframe image (YES), the processing advances to Step S107, and in the case of not having received a photoframe image (NO), i.e. case of receiving a marker authentication failure, the processing returns to Step S105. In the case of the processing returning to Step S105, the control unit 10 causes the individual packaging 300 of the selected furikake to be photographed again by the camera 14, and sends the photographed merchandise image to the information supplying server 2 via the communication unit 15. In Step S107, the control unit 10 displays the user interface 400 superimposing the received photoframe image on the display unit 12, and by the photography button 420 being operated by a tap operation or the like on the input unit 11 by the user U, causes the composite image 500 to be photographed by the camera 14, for example. In Step S108, the control unit 10 stores the photographed composite image 500 in the storage unit 13.

In accordance with the above, the information supplying system according to the present embodiment prepares in advance a plurality of types of information to be supplied to the user U for every merchandise. The information supplying system selects one set of information randomly (for example, photoframe image) from the plurality of types of information sets every time receiving a merchandise image from the terminal device 1, and sends to the terminal device 1. The information supplying system can thereby motivate the user U to purchase this merchandise also next time in order to obtain all sets of information (photoframe images), and can give the user U also a sense of excitement of not knowing which information set (photoframe image) would be sent.

Although the present embodiment has been explained above, the information supplying system is not to be limited to the aforementioned embodiment, and that modifications, improvements, etc. in a scope which can achieve the object are also encompassed thereby.

### Modified Example 1

In the aforementioned embodiment, the authentication unit 31 and selection unit 32 are provided to the information supplying server 2; however, it is not limited thereto. For example, the terminal device 1 may have the entirety or part of the functions of the information supplying server 2. For example, by being included in the terminal device 1, the authentication unit 31 may send information indicating the merchandise specified by the marker authentication from the merchandise image to the information supplying server 2, in place of the merchandise image photographed by the camera 14. It is thereby possible to reduce the data volume sent and received between the terminal device 1 and information supplying server 2.

### Modified Example 2

In the aforementioned embodiment, the item packaging design of the overall merchandise (for example, “furikake”) is photographed in the camera 14 as an AR marker; however, it is not limited thereto. For example, the camera 14 may photograph the item packaging design of part of the merchandise as an AR marker, and establish as the merchandise image. For example, in the individual packaging 300 shown in FIG. 7, the rectangular region 310 in which a picture pattern such as a panda is printed may be photographed by the camera 14 as the AR marker.

### Modified Example 3

In the aforementioned embodiment, the camera 14 photographs the composite image 500 by the photography button 420 being operated by a tap operation or the like on the input unit 11 by the user U on the user interface 400; however, it is not limited thereto. The camera 14 may photograph a video composited with the photoframe image, by the photography button 420 being operated by way of a tap operation or the like on the input unit 11 by the user U on the user interface 400.

It should be noted that each function included in the information supplying system according to the aforementioned embodiment can be realized by hardware, software or a combination of these, respectively. Herein, being realized by software indicates the matter of being realized by a computer reading out and executing programs.

The program can be stored using various types of non-transitory computer readable media, and supplies to a computer. Non-transitory computer readable media includes various types of tangible storage media. Examples of non-transitory computer readable media include magnetic recording media (for example, flexible disk, magnetic tape, hard disk drive), magneto-optical media (for example, magneto-optical disk), CD-ROM (Read Only Memory), CD-R, CD-R/W, semiconductor memory (for example, mask ROM, PROM (Programmable ROM), EPROM (Erasable PROM), flash ROM, and RAM.

It should be noted that the steps encoding programs recorded on the recording medium, while naturally processing performed in chronological order following this sequence, are not necessarily processed in chronological order, and also includes processing executed in parallel or discretely.

### EXPLANATION OF REFERENCE NUMERALS

1 terminal device
2 information supplying server
3 network
10 control unit
11 input unit
12 display unit
13 storage unit
14 camera
15 communication unit
20 communication unit
21 control unit
22 storage unit
31 authentication unit
32 selection unit

What is claimed is:

1. A non-transitory computer readable storage medium encoded with an information supplying program executed by a computer having a display unit, the program comprising:
an authentication step of performing authentication for accessing an AR library which causes an imaging device to operate as an AR camera;
a photography step of photographing an item packaging design of merchandise by the imaging device;
a selection step of selecting a set of information based on the item packaging design of merchandise that was photographed, from among a plurality of sets of information related to the merchandise; and
a display step of displaying the set of information selected on the display unit.

2. The non-transitory computer readable storage medium encoded with the information supplying program according to claim 1,
wherein the selection step selects the information as one photoframe image randomly from among a plurality of photoframe images stored to correspond to the item packaging design photographed,
wherein the display step superimposes the photoframe image which was selected on a live-view image of the imaging device and displays on the display unit,
wherein the information supplying program further comprises a storage step of storing a composite image made by compositing an image photographed by the imaging device and the photoframe image.

3. The non-transitory computer readable storage medium encoded with the information supplying program according to claim 1, wherein the item packaging design includes at least one of a letter, a picture pattern and a graphic.

4. An information supplying method comprising:
a step of performing authentication for accessing an AR library which causes an imaging device to operate as an AR camera;
a step of photographing an item packaging design of merchandise by the imaging device;
a step of selecting, from among a plurality of sets of information related to the merchandise, a set of information based on the item packaging design of the merchandise; and
a step of displaying the set of information which was selected.

5. An information supplying system which accepts images of merchandise from a user and provides information related to the merchandise to the user, the system comprising:
an imaging device which photographs an item packaging design of the merchandise;
an authentication unit which performs authentication for accessing an AR library which causes the imaging device to operate as an AR camera;
a selection unit which selects, from among a plurality of sets of information related to the merchandise, a set of information based on the item packaging design of the merchandise which was photographed by the imaging device; and
a display unit which displays the set of information which was selected.
